(19) United States
(12) Patent Application Publication
(10) Pub. No.: US 2025/0144651 A1
(43) Pub. Date: May 8, 2025

(54) NOZZLE ARRANGEMENT FOR APPLYING FLUIDS, AND METHOD FOR PRODUCING A MAIN BODY OF SUCH A NOZZLE ARRANGEMENT

(71) Applicant: Illinois Tool Works Inc., Glenview, IL (US)

(72) Inventor: Andreas Pahl, Erkrath (DE)

(73) Assignee: Illinois Tool Works Inc., Glenview, IL (US)

(21) Appl. No.: 19/019,084

(22) Filed: Jan. 13, 2025

Related U.S. Application Data
(62) Division of application No. 16/814,650, filed on Mar. 10, 2020, now Pat. No. 12,226,792.

(30) Foreign Application Priority Data
Mar. 11, 2019 (DE) 10 2019 106 163.6

(51) Int. Cl. B05B 7/08; B22F 10/28; B22F 10/80; B22F 12/53; B22F 12/55; B29C 64/153; B29C 64/209; B33Y 10/00; B33Y 30/00

(52) U.S. Cl. CPC B05B 7/0884; B22F 10/28; B22F 10/80; B22F 12/53; B22F 12/55; B29C 64/153; B29C 64/209; B33Y 10/00; B33Y 30/00

(57) ABSTRACT

A nozzle arrangement for applying fluids to a substrate has a main body which is able to be connected to a mounting region of a distributor and which has an end-side side surface. At least one first outlet nozzle for the fluid to be applied to the substrate is provided in or on the end-side side surface of the main body. A first fluid channel system is formed in the main body, via which the at least one first outlet nozzle is connected in terms of flow to a first fluid connector, which is provided in the main body of the nozzle arrangement. The nozzle arrangement is a monolithic component produced by an additive production method.

### CROSS-REFERENCE TO RELATED APPLICATIONS

This application is a divisional of, and claims priority to, U.S. patent application Ser. No. 16/814,650 (filed 10 Mar. 2020), which claims priority to DE patent application 10 2019 106 163.6 pursuant to 35 U.S.C. § 119 and 37 C.F.R. § 1.55 (filed 11 Mar. 2019). The entire disclosures of these applications are incorporated herein by reference.

### BACKGROUND

### Technical Field

The inventive subject matter relates in general to the applying of fluids, including thermoplastic or fibrous adhesives, to a substrate through at least one nozzle arrangement which is preferably releasably secured to a mounting surface of a distributor or a distributor head.

The distributor or distributor head generally serves for supplying the fluid being applied to the at least one nozzle arrangement. The purpose of such a system is to apply fluids to substrates which are moving for example relative to the at least one nozzle arrangement, in particular to apply adhesives in partial spraying patterns for the partial covering of a substrate.

### Discussion of Art

Document EP 0 872 580 A discloses for example a plurality of melt blowing nozzle arrangements or nozzles which can be secured, side by side, to one or both ends of a conventional distributor or distributor head, which ensures a metered supplying of adhesive to each nozzle arrangement. The nozzle arrangements each comprise a plurality of substantially parallel plate elements, forming a row of adhesive dispensing openings on an exit surface. The row of fluid outlet openings of each nozzle arrangement forms a section of a longer row, formed by the plurality of adjacent nozzle arrangements, which are situated along a common end of the distributor head. One or both sides of the distributor can be secured next to the side of a similarly constructed distributor head in order to form even longer rows of fluid outlet openings, thereby providing a modular melt blowing adhesive dispensing system to accommodate substrates of any dimensional width.

The nozzle arrangements considered here have a very compact design. In particular, it is desirable to accommodate in the main body of the nozzle arrangement the highest possible number of outlet nozzles for the fluid being applied to the substrate and/or for other fluids, such as shaping air. In this way, an extremely flat and uniform application of fluids to the substrate surface is possible.

However, the number of outlet nozzles per main body of a nozzle arrangement cannot be increased arbitrarily, since a fluid channel system needs to be formed for each outlet nozzle inside the main body, in order to connect the outlet nozzle fluidically to a fluid port, likewise provided on the main body of the nozzle arrangement. This fluid port on the main body of the nozzle arrangement can be connected to a complementary port of a distributor or distributor head when the nozzle arrangement is mounted in the mounting region of the distributor/distributor head.

FIG. 1 shows part of a conventional nozzle arrangement known from the prior art, revealing the laminated construction.

FIG. 2 shows the nozzle assembly of FIG. 1 in an exploded view.

Specifically, it will be noticed in FIGS. 1 and 2 that the conventional nozzle arrangement 100 is formed from a number of individual plates 101.1 to 101.6, which are joined flush with each other in the assembled state (see FIG. 1). For this, a pin element may be used, for example, which is inserted through a corresponding hole 102 or through a corresponding opening in the individual plates 101.1 to 101.6 and holds the individual plates 101.1 to 101.6 together.

Recesses or holes 103 to 107 are provided in the individual plates 101.1 to 101.6, which in the assembled state form a fluid channel system in the main body 101 of the nozzle arrangement 100, in order to connect the individual outlet nozzles 108 at one end face of the nozzle assembly fluidically to the fluid port on the main body 101 of the nozzle assembly.

With the aid of the drawings in FIGS. 1 and 2 it can be seen that the laminated construction of the nozzle arrangement 100 does not allow the forming of arbitrarily designed fluid channel systems inside the main body 101. Furthermore, the number of individual fluid channel systems in the main body 101 of the nozzle arrangement 100 is limited, as is the number of individual outlet nozzles 108, 109 on the end-side lateral surface of the main body 101, serving to dispense an adhesive or to dispense shaping air and being arranged alternating with each other in a row.

### BRIEF DESCRIPTION

Based on this statement of the problem, the problem which the inventive subject matter proposes to solve is to modify a nozzle arrangement of the kind mentioned above so that a larger number of outlet nozzles and/or a more complex fluid channel system can be provided in the main body of the nozzle arrangement.

In particular, a solution should be provided with which the fluid channel systems formed in the main body of the nozzle arrangement can be adapted to the particular application as optimally as possible. Optimal means in this context that the fluid channel systems being formed inside the main body have a configuration such that the flow resistance in particular can be reduced.

This problem is solved according to the inventive subject matter by the subject matter of the independent patent claim 1, which concerns a nozzle arrangement for the applying of fluids, especially thermoplastic adhesives, to a substrate.

The nozzle arrangement according to the inventive subject matter comprises—like the nozzle arrangements of this kind that are known in the prior art—a main body which is able to be connected, preferably exchangeably, to a mounting region of a distributor or distributor head and having an end-side lateral surface. In or on the end-side lateral surface of the main body there is provided at least one and preferably a plurality of first outlet nozzles for the fluid to be applied to the substrate.

Furthermore, it is provided according to the inventive subject matter that there is formed in the main body a first fluid channel system, via which the at least one first outlet nozzle is connected fluidically to a first fluid port, which is provided in the main body of the nozzle arrangement.

Unlike the nozzle arrangements known in the prior art, it is provided according to the inventive subject matter that the nozzle arrangement is a monolithic component produced by an additive manufacturing method.

Accordingly, a traditional laminated construction of the nozzle arrangement is deliberately avoided in this application. Instead, it is proposed to form at least the main body of the nozzle arrangement together with the fluid channel system provided in the main body and together with the at least one outlet nozzle provided on or in the end face of the main body with the aid of an additive manufacturing method.

This allows for significantly more complex geometries and configurations, especially for the at least one first fluid channel system inside the main body. Moreover, significantly more complex structures can be realized and a significantly larger number of outlet nozzles at or in the end face of the main body, given the same geometrical dimensions of the main body.

As a further advantage, it should be mentioned in particular that even complex fluid channel systems can be realized inside the main body with the aid of the additive manufacturing method. Such complex fluid channel systems may have at least partially three-dimensional curved fluid channel sections.

In other words, with the inventive subject matter the fluid channel systems inside the main body of the nozzle arrangement can be optimally adapted to the particular application. Thanks to the possibility of forming three-dimensional curved fluid channel sections inside the main body of the nozzle arrangement, the flow behavior of the fluid being supplied through the main body can also be adapted or optimized, especially in regard to the least possible flow resistance.

According to embodiments of the inventive subject matter, in or on the end-side lateral surface of the main body there is provided at least one second outlet nozzle and preferably a plurality of second outlet nozzles for the purpose of dispensing shaping air in a targeted manner in order to influence, for example, the direction of a fluid jet discharged from the at least one first outlet nozzle. The at least one second outlet nozzle is connected fluidically to a second fluid port, which is provided on the main body of the nozzle arrangement, via a second fluid channel system formed in the main body.

Thanks to the additive manufacturing method it is possible for the second fluid channel system to also have at least one fluid channel section formed in a partially three-dimensionally curved manner and thus to optimize the supply of fluid to the second outlet nozzle especially in terms of the expected flow resistance.

The additive manufacturing method by which the nozzle arrangement is created, according to realizations of the solution according to the inventive subject matter, has the step of determining three-dimensional information about the main body, wherein the main body contains the at least one first and/or at least one second outlet nozzle, and the first and/or second fluid channel system is formed integrally in the main body.

The additive manufacturing method has the further step of converting the three-dimensional information into a plurality of layers, these layers defining the cross-sectional layers of the main body. At least one empty space within at least one of the layers is defined, which defines the first and/or second fluid channel system.

Finally, each layer of the main body is formed in succession, in particular by melting a metallic powder using laser energy and/or electrode beam energy.

Of course, however, it is also conceivable that the individual layers of the main body are formed from another material, such as ceramic material or plastic material.

Preferably, a laser sintering method or a direct metal laser sintering (DMLS) method is used during the additive manufacturing method.

The successive forming of each layer of the main body by melting a metallic powder using laser energy moreover involves, according to modifications of the solution according to the inventive subject matter, a melting of a metallic powder comprising at least one of cobalt-chromium, HS188 and INCO625.

Alternatively or additionally, the successive forming of each layer of the main body by melting a metallic powder using laser energy can moreover involve a melting of a metallic powder having a particle size between approximately 10 μm and approximately 75 μm, preferably between approximately 15 μm and approximately 30 μm.

According to one preferred realization of the nozzle arrangement according to the inventive subject matter, an extension region is formed by the additive manufacturing method on the end-side lateral surface of the main body, in which the at least one first outlet nozzle is formed, wherein the extension region and the at least one first outlet nozzle are formed such that the outlet opening of the at least one first outlet nozzle is at a distance from the end-side lateral surface of the main body, and wherein a main flow axis which is predefined by the at least one first outlet opening, along which the fluid is discharged from the at least one first outlet nozzle, makes an acute angle with the end-side lateral surface of the main body.

This modification of the nozzle arrangement according to the inventive subject matter is in particular an optimized nozzle arrangement for the applying of fluids, especially thermo-plastic adhesives, to substrates having a correspondingly complex geometry and therefore requiring a corresponding application method.

Because of the fact that the nozzle arrangement in this embodiment is provided with a corresponding extension region in which the at least one first outlet nozzle is formed, the nozzle arrangement, especially when it is arranged [in] a distributor head carried on a robot arm, can also be used in flexible manner in areas of complex geometry without the danger of the nozzle arrangement or the distributor head coming into contact with areas of the substrate being coated.

Moreover, it is ensured that the nozzle outlet opening of the at least one first outlet nozzle always maintains the given distance from the surface of the area of the substrate being coated. In particular, the special geometry of the nozzle arrangement with the extension region allows the nozzle arrangement to also be swiveled and turned relative to the substrate being coated or the area of the substrate being coat-ed, which is necessary for a uniform wetting of the area with the fluid, especially the thermoplastic adhesive.

According to preferred realizations of the last mentioned embodiment of the nozzle arrangement according to the inventive subject matter, it is provided in particular that—looking in plan view—the main body of the nozzle arrangement is at least substantially rectangular. Moreover, it is provided that—likewise looking in plan view—the extension region of the nozzle arrangement is at least substantially trapezoidal or triangular, especially trapezoidal, and is connected by its longer base side to the end face of the main body.

Because of the fact that the main body in this embodiment—as in the prior art—has an at least substantially rectangular configuration (again in plan view), the nozzle arrangement can again be connected to the mounting region of the distributor head without requiring design changes to the mounting region or to the distributor head. The same also holds for the fluid distribution system which is provided by the distributor head and which is provided by a corresponding intersection region with the fluid channel system integrated in the main body of the nozzle arrangement.

In modification of the last mentioned embodiment it is provided in particular that one leg of the especially trapezoidal extension region in plan view is flush with a lateral surface of the main body. Alternatively or additionally, it can be provided that the at least one outlet opening is formed in one leg of the especially trapezoidal extension region in plan view, situated opposite the leg which is flush with the lateral surface of the main body of the nozzle arrangement.

These modifications are especially easy to realize, yet still effective solutions for designing the nozzle arrangement according to the inventive subject matter so that even particular-ly complex geometrical regions of the substrate being coated can effectively arrive in the area of the at least one first outlet nozzle of the nozzle arrangement without any contact occurring between the nozzle arrangement or the distributor or distributor head and the substrate.

According to the inventive subject matter, it is provided that the entire nozzle arrangement is a monolithic component created by an additive manufacturing method. In other words, all structural features of the nozzle arrangement are formed integrally in the main body of the nozzle arrangement. The integral design has the advantage that the entire nozzle arrangement and especially the orientation of the at least one first outlet nozzle or the outlet opening of the at least one first outlet nozzle and the corresponding fluid channel system in the interior of the main body of the nozzle arrangement can be produced with high precision and only extremely small tolerances.

All in all, the configuration of the nozzle arrangement according to the inventive subject matter as a monolithic nozzle subassembly makes possible a compact nozzle arrangement in which all necessary functionalities are integrated.

According to realizations of the solution according to the inventive subject matter, it is provided that the nozzle arrangement is produced by means of 3D printing. In particular, the laser sintering method or microlaser sintering, also known as selective laser melting (SLM), can be used here. Thanks to this manufacturing method, the at least one first fluid channel system inside the main body of the nozzle arrangement can have a curved configuration in multiple planes, in order to achieve perfect flows. Further-more, no mounting of the first outlet nozzle on the main body of the nozzle arrangement is necessary, since the latter is also integrated with the main body of the nozzle arrangement. In this way, every possible assembly error and every tolerance discrepancy due to the assembly process can be prevented.

In the former laminar designed nozzle (prior art), a metallic sealing is accomplished only by screwing together the individual nozzle plates by the outer clamping plates. It is a constant challenge in this case to put enough screws in place to achieve an adequate surface pressure. This also means a design limitation, since no glue and/or air channels can be placed in the position of the screws (and additional positioning pins). Minimum distances from the screw boreholes also have to be maintained in order to achieve the sealing. Leakage also occurs constantly in the case of newly designed nozzles.

According to one aspect of the inventive subject matter, it is provided that the fluid, especially the thermoplastic adhesive, can be dispensed with the at least one first outlet nozzle in a predetermined event sequence. In particular, the nozzle arrangement according to the inventive subject matter is suitable for dispensing the fluid (that is, the thermoplastic adhesive) with a pattern, especially an oscillating pattern.

For this, it is provided according to embodiments of the nozzle arrangement according to the inventive subject matter that the outlet opening of the at least one first outlet nozzle of the nozzle arrangement is preferably coordinated with a plurality of fluid openings of second outlet nozzles, where these fluid openings dispense forming or deflecting air, in order to specifically deflect the fluid dispensed from the outlet opening of the at least one first outlet nozzle from the main flow axis. The plurality of the (additional) fluid openings, which are provided by the second outlet nozzles and which serve for dispensing corresponding forming or deflecting air, may be slanted to converge on the main flow axis of the outlet opening of the first outlet nozzle.

The inventive subject matter is not confined to nozzle arrangements having a corresponding extension region for example at the end-side lateral surface of the main body. Instead, the inventive subject matter is especially suitable for all nozzle arrangements having a relatively com-plex construction, and/or requiring an elevated number of outlet nozzles (first and/or second outlet nozzles).

The inventive subject matter moreover relates to a corresponding method for producing a main body of a nozzle arrangement for applying fluids, in particular thermoplastic adhesives, to a substrate, wherein the main body has at least one first outlet nozzle and preferably at least one second outlet nozzle, and wherein, in the main body, there are/is formed at least one first fluid channel system and/or at least one second fluid channel system, via which the at least one first and/or at least one second outlet nozzle are/is connected fluidically to a first and/or second port on the main body of the nozzle arrangement.

Example embodiments of the solution according to the inventive subject matter will be described more closely below, making reference to the enclosed drawings.

### BRIEF DESCRIPTION OF THE DRAWINGS

FIG. 1 schematically, a conventional nozzle arrangement with a laminated construction, known in the prior art;

FIG. 2 schematically, the nozzle arrangement known in the prior art per FIG. 1 in an exploded view;

FIG. 3 schematically and in a partially see-through isometric view, an example embodiment of the nozzle arrangement according to the inventive subject matter;

FIG. 4 schematically and in a plan view, the example embodiment of the nozzle arrangement according to the inventive subject matter per FIG. 3; and

FIG. 5 schematically and in a partially see-through isometric view, another example embodiment of the nozzle arrangement according to the inventive subject matter.

### DETAILED DESCRIPTION

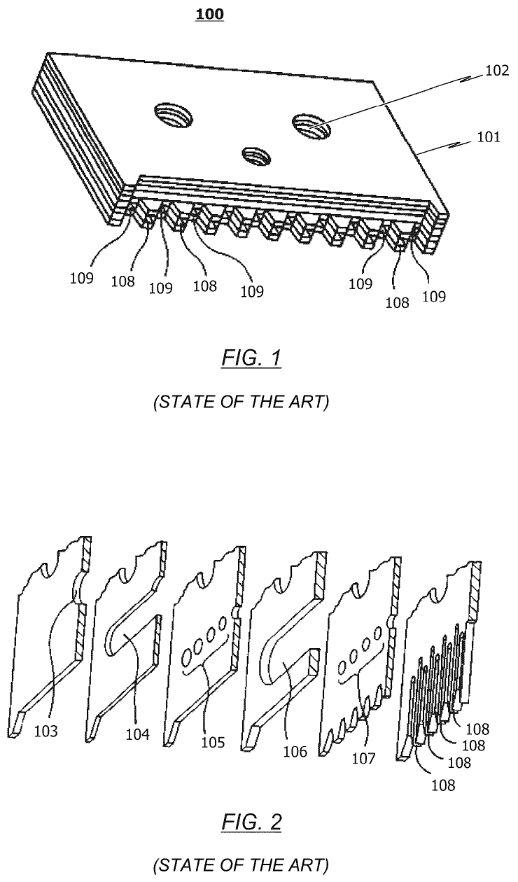

FIG. 1 shows part of a conventional nozzle arrangement 100 known in the prior art, revealing the laminated construction.

FIG. 2 shows the nozzle arrangement 100 of FIG. 1 in an exploded view.

Specifically, it can be seen in FIGS. 1 and 2 that the conventional nozzle arrangement 100 is composed of a plurality of individual plates 101.1 to 101.6, which are joined flush with each other in the assembled state (see FIG. 1). For this, a pin element can be used, for example, which is inserted through a corresponding hole 102 or through a corresponding opening in the individual plates 101.1 to 101.6 and holds the individual plates 101.1 to 101.6 together.

Various recesses or holes 103 to 107 are provided in the individual plates 101.1 to 101.6, which in the assembled state form a fluid channel system in the main body 101 of the nozzle arrangement 100, in order to connect the individual outlet nozzles 108 at one end face of the nozzle assembly fluidically to a fluid port on the main body 101 of the nozzle assembly.

It can be seen from the representations in FIGS. 1 and 2 that the laminated construction of the nozzle arrangement does not allow the forming of arbitrarily designed fluid channel systems inside the main body 101. Furthermore, the number of individual fluid channel systems in the main body 101 of the nozzle arrangement 100 is limited, as is the number of individual outlet nozzles 108 on the end-side lateral surface of the main body 101.

In order to accomplish a larger number of outlet nozzles 108 and/or a more complex fluid channel system in the main body 101 of the nozzle arrangement 100—as com-pared to the nozzle arrangements 100 known in the prior art—it is proposed according to the inventive subject matter that the nozzle arrangement is a monolithic component generated by an additive manufacturing method.

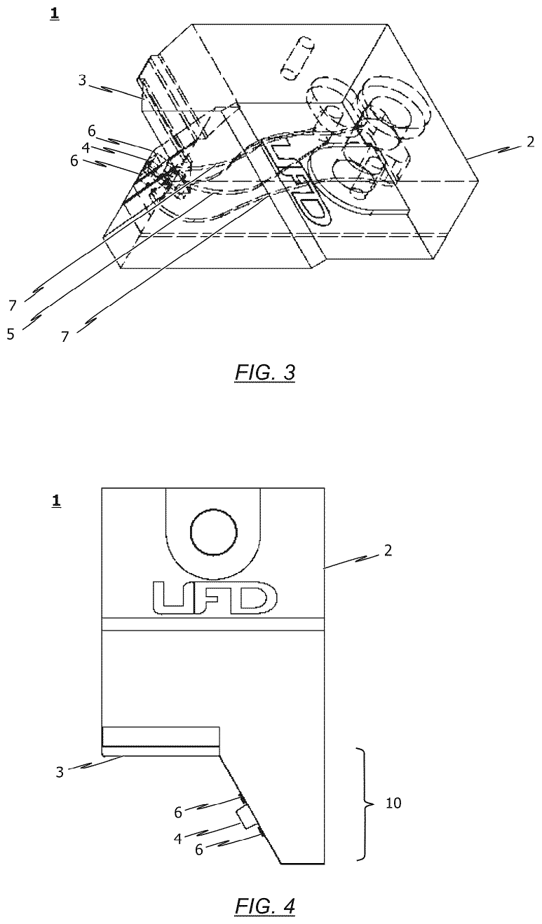

An example embodiment of the nozzle arrangement 1 according to the inventive subject matter is shown in FIG. 3 (in a partly see-through isometric view) and in FIG. 4 (in a plan view).

Briefly summarized, the example embodiment of the nozzle arrangement 1 according to the inventive subject matter shown schematically in FIG. 3 and FIG. 4 is a monolithic component generated by an additive manufacturing method.

The nozzle arrangement 1 comprises a main body 2 having an end-side lateral sur-face, which is able to be connected, preferably exchangeably, to a mounting region of a distributor or distributor head and having in or on the end-side lateral surface 3 of the main body 2 at least one first outlet nozzle 4 for a fluid to be applied to a substrate with the aid of the nozzle arrangement 1.

Furthermore—as can be seen in particular from the representation in FIG. 3—there is formed in the main body 2 of the nozzle arrangement 1 a first fluid channel system 5, via which the at least one first outlet nozzle 4 is connected fluidically to a first fluid port, which is provided in the main body 2 or on the main body 2 of the nozzle arrangement 1.

Moreover, it can be seen from the representation of FIG. 3 that in or on the end-side lateral surface 3 of the main body 2 there is provided at least one further second outlet nozzle 6 for the purpose of dispensing shaping air in a targeted manner via this at least one second outlet nozzle 6 in order to influence, as needed, the direction of a fluid jet discharged from the at least one first outlet nozzle 5.

It is likewise seen from the partly see-through representation of FIG. 3 that the at least one second outlet nozzle 6 for shaping air is connected fluidically by a second fluid channel system 7 formed in the main body 2 to a second fluid port provided on the main body 2 of the nozzle arrangement 1.

Thanks to the additive manufacturing method with which at least the main body 2 of the nozzle arrangement 1 is produced, it is possible for the first fluid channel system 5 and the at least one further, second fluid channel system 7 to have at least fluid channel sections formed in a partially three-dimensionally curved manner, as can likewise be seen from the representation of FIG. 3.

The example embodiment of the nozzle arrangement 1 according to the inventive subject matter that is shown in FIGS. 3 and 4 is a nozzle arrangement 1 designed in particular to apply fluids, such as thermoplastic adhesives, to substrates with a correspondingly complex geometry.

For this purpose, an extension region 10 is formed on the end-side lateral surface 3 of the main body 2 of the nozzle arrangement 1, in which the at least one first outlet nozzle 4 for the fluid being applied to the substrate is formed. The extension region 10 and the first outlet nozzle 4 are formed such that the outlet opening of the first outlet nozzle 5 is at a distance from the end-side lateral surface 3 of the main body 2 of the nozzle arrangement 1.

Moreover, it may be provided that a main flow axis which is predefined by the outlet opening of the first outlet nozzle 5, along which the thermoplastic adhesive material is discharged from the first outlet nozzle 5, makes an acute angle with the end-side lateral surface 3 of the main body 2.

In the example embodiment of the nozzle arrangement 1 according to the inventive subject matter shown in FIG. 3 and FIG. 4 it is provided in particular that—looking in plan view—the main body 2 of the nozzle arrangement 1 is at least substantially rectangular, and that—likewise looking in plan view—the extension region 10 is at least substantially trapezoidal, and is connected by its longer base side to the end face of the main body 2. Specifically, one leg of the trapezoidal extension region 10 in plan view is flush with a lateral surface 3 of the main body 2.

Moreover, it is provided that the at least one outlet opening of the first outlet nozzle 5 is formed in one leg of the trapezoidal extension region 10 as seen in plan view, situated opposite the leg which is flush with the lateral surface 3 of the main body 2.

In the nozzle arrangement 1 according to the inventive subject matter, the extension region 10 together with the at least one first outlet nozzle 4 in the extension region 10 and together with the rest of the main body 2 of the nozzle arrangement 1 is formed as a monolithic component with the aid of an additive manufacturing method.

Thus, corresponding fluid channel systems 5, 7 can be formed in especially simple manner in the main body 2 and in the extension region 10 of the nozzle arrangement 1, which are fluidically connected to the first outlet nozzle 5 and/or to the second outlet nozzles 6 of the nozzle arrangement 1.

As already indicated and as can be seen schematically in FIG. 3, the outlet opening of the first outlet nozzle 4 is associated with one and preferably with a plurality of further fluid openings, whose main axis along which a fluid (especially pressurized air) is dispensed from the further fluid openings is slanted in the direction of the main flow axis of the outlet opening of the first outlet nozzle 4. Moreover, it is provided that the fluid openings of the second outlet nozzle 6 are offset in regard to the outlet opening of the first outlet nozzle 4 in the direction of the lateral surface 3 of the extension region 10 on or in which the outlet opening of the first outlet nozzle 4 is formed.

With the aid of these fluid openings of the second outlet nozzle 6, it is possible to steer compressed air in the direction of the jet of thermoplastic adhesive dispended by the first outlet nozzle 5, and thereby deflect the jet of adhesive as needed. In particular, in this way it is possible to deflect the jet of adhesive dispensed through the first outlet nozzle 4 periodically from the main flow axis, for example in order to form an Omega-shaped pattern of the jet of adhesive applied to the substrate.

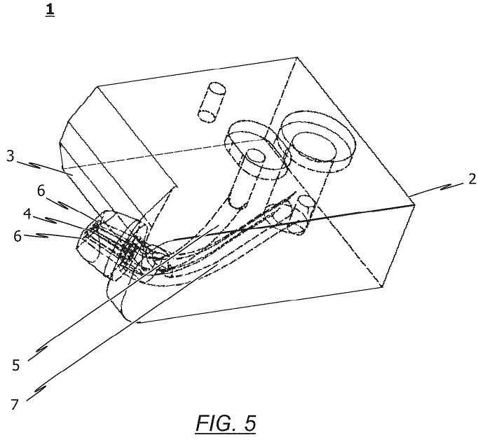

FIG. 5 shows schematically and in a partly see-through isometric view a further example embodiment of the nozzle arrangement 1 according to the inventive subject matter. This nozzle arrangement 1 corresponds substantially in structural and functional respects to the nozzle arrangement 1 of FIG. 3; however, the representation of FIG. 5 shows the fluid channel systems 5, 7 formed in the main body 2, especially their curved configuration in multiple axes.

The inventive subject matter is not confined to the example embodiments shown in the drawings, but rather emerges from a combined consideration of all the features disclosed herein.

1. A nozzle arrangement for applying fluid to a substrate, the nozzle arrangement comprising:
a main body configured to be connected to a mounting region of a distributor, the main body including an end-side side surface with at least one first outlet nozzle for the fluid to be applied to the substrate, the at least one first outlet nozzle in or on the end-side side surface of the main body,
wherein, a first fluid channel system is formed in the main body, via which the at least one first outlet nozzle is fluidly connected to a first fluid connector provided in the main body, the first fluid channel system having a three-dimensionally curved fluid channel section that is curved along multiple axes.

2. The nozzle arrangement of claim 1, wherein at least one second outlet nozzle is in or on the end-side side surface of the main body for dispensing shaping air in a targeted manner to influence a direction of a fluid jet dispensed from the at least one first outlet nozzle, wherein the at least one second outlet nozzle is fluidly connected to a second fluid connector on the main body via a second fluid channel system formed in the main body.

3. The nozzle arrangement of claim 2, wherein the second fluid channel system also has the three-dimensionally curved fluid channel section.

4. The nozzle arrangement of claim 2, wherein the nozzle arrangement is a monolithic component formed by a plurality of additive production layers.

5. (canceled)

6. The nozzle arrangement of claim 2, wherein an extension region in which at least one of the first outlet nozzle or the second outlet nozzle is formed is located on the end-side side surface of the main body, wherein the extension region and the at least one of the first outlet nozzle or the second outlet nozzle are formed such that an outlet opening of the at least one of the first outlet nozzle or the second outlet nozzle is at a distance from the end-side side surface of the main body and a main flow axis, the main flow axis predefined by the outlet opening of the at least one of the first outlet nozzle or the second outlet nozzle and along which the fluid dispensed from the at least one first outlet nozzle moves, encloses an acute angle with the end-side side surface of the main body.

7. The nozzle arrangement of claim 6, wherein the main body is at least substantially of right-angled form, and wherein the extension region is at least substantially of trapeziform or triangular form and is connected via a longer base side of the extension region to the end side of the main body.

8. The nozzle arrangement of claim 7, wherein the outlet opening of the at least one first outlet nozzle is assigned at least one fluid opening of the second outlet nozzle, the fluid opening having a main flow axis along which the fluid dispensed from the fluid opening of the at least one second outlet nozzle moves, the main flow axis inclined in the direction of the main flow axis of the outlet opening of the first outlet nozzle.

9. An additive production method comprising:
melting a material to form several nozzle layers, the nozzle layers forming a nozzle arrangement for applying fluid to a substrate, the nozzle arrangement formed by melting the material to have a main body configured to be connected to a mounting region of a distributor, the main body including an end-side side surface with an outlet nozzle for the fluid to be applied to the substrate, the outlet nozzle formed in or on the end-side side surface of the main body, the main body including a fluid channel system via which the outlet nozzle is fluidly connected to a fluid connector also formed in the main body, the fluid channel system having a three-dimensionally curved section that curves along multiple axes.

10. The additive production method of claim 9, wherein the outlet nozzle is a first outlet nozzle, the fluid channel system is a first fluid channel system, the fluid connector is a first fluid connector, and melting the material to form the several nozzle layers also forms a second outlet nozzle in or on the end-side side surface of the main body, the second outlet nozzle formed for dispensing shaping air in a targeted manner to influence a direction of a fluid jet dispensed from the first outlet nozzle, the second outlet nozzle formed to be fluidly connected to a second fluid connector on the main body via a second fluid channel system formed in the main body.

11. The additive production method of claim 10, wherein the three-dimensionally curved section is a first three-dimensionally curved section, and the second fluid channel system formed by melting the material has a second three-dimensionally curved fluid channel section that curves along multiple axes.

12. The additive production method of claim 10, further comprising:
determining three-dimensional information about the main body that includes the first outlet nozzle and the second outlet nozzle and in which the first and second fluid channel systems are formed; and
defining cross-sectional layers of the main body using the three-dimensional information, wherein at least one empty space that defines the first and second fluid channel systems is defined within at least some of the cross-sectional layers, wherein melting the material includes successively forming each of the nozzle layers of the main body by melting a metallic powder as the material using one or more of laser energy or electron beam energy.

13. The additive production method of claim 10, wherein melting the material to form the several nozzle layers also forms an extension region in which at least one of the first outlet nozzle or the second outlet nozzle is formed is located on the end-side side surface of the main body.

14. The additive production method of claim 13, wherein melting the material to form the several nozzle layers form the extension region and the at least one of the first outlet nozzle or the second outlet nozzle such that an outlet opening of the at least one of the first outlet nozzle or the second outlet nozzle is at a distance from the end-side side surface of the main body and a main flow axis.

15. The additive production method of claim 14, wherein the main flow axis is predefined by the outlet opening of the at least one of the first outlet nozzle or the second outlet nozzle and along which the fluid dispensed from the first outlet nozzle moves.

16. The additive production method of claim 13, wherein the main body is at least substantially of right-angled form, and wherein the extension region is at least substantially of trapeziform or triangular form and is connected via a longer base side of the extension region to the end side of the main body.

17. The additive production method of claim 16, wherein the outlet opening of the first outlet nozzle is assigned at least one fluid opening of the second outlet nozzle.

18. The additive production method of claim 17, wherein the fluid opening has a main flow axis along which the fluid dispensed from the fluid opening of the second outlet nozzle moves.

19. The additive production method of claim 18, wherein the main flow axis is inclined in the direction of the main flow axis of the outlet opening of the first outlet nozzle.

20. The additive production method of claim 9, wherein melting the material includes using laser sintering or direct metal laser sintering (DMLS) to melt the material and form the nozzle layers.

21. A nozzle arrangement for applying fluid to a substrate, the nozzle arrangement comprising:
a main body configured to be connected to a mounting region of a distributor, the main body including an end-side side surface with a first outlet nozzle for the fluid to be applied to the substrate and a second outlet nozzle for dispensing shaping air to influence a direction of a fluid jet dispensed from the first nozzle, the first outlet nozzle in or on the end-side side surface of the main body, the main body including a first fluid channel system via which the first outlet nozzle is fluidly connected to a first fluid connector in the main body, the second outlet nozzle located in or on the end-side side surface of the main body, the second outlet nozzle fluidly connected to a second fluid connector on the main body via a second fluid channel system formed in the main body,
wherein at least one of the first fluid channel system or the second fluid channel system has a three-dimensionally curved fluid channel section that is curved along multiple axes.
